(19) United States
(12) Patent Application Publication
(10) Pub. No.: US 2003/0026550 A1
(43) Pub. Date: Feb. 6, 2003

(54) Optical connector ferrule having a wavy slot

(76) Inventor: Drew A. Demangone, Latrobe, PA (US)

Correspondence Address: HARRINGTON & SMITH, LLP, 4 RESEARCH DRIVE, SHELTON, CT, 06484-6212, US

(21) Appl. No.: 09/923,169

(22) Filed: Aug. 6, 2001

(51) Int. Cl. G02B 6/36

(52) U.S. Cl. 385/78

(57) ABSTRACT

An optical connector ferrule comprising a main section comprising optical fiber receiving areas, and side sections on opposite lateral sides of the main section. The optical fiber receiving areas comprise a single slot which is sized and shaped to receive a plurality of spaced optical fibers and is adapted to keep the optical fibers spaced from each other in the slot.

### BACKGROUND OF THE INVENTION

1. Field of the Invention

The present invention relates to optical connectors and, more particularly, to an optical connector ferrule having an optical member receiving slot with general wavy shaped opposing surfaces.

2. Brief Description of Prior Developments

Conventional optical connector ferrules can be manufactured by use of a ceramic injection mold. One type of optical connector ferrule uses separate opposing ferrule pieces. Another type of optical connector ferrule comprises a one-piece ferrule member with discrete fiber holes. U.S. Pat. No. 5,963,691 discloses a conventional fiber optic ferrule which has discrete fiber holes for each respective fiber of a cable. This style of ferrule, with discrete fiber holes, as a very thin wall thickness between the fibers that is difficult to mold. A mold member used in the ceramic injection mold for this type of fiber optic ferrule has a plurality of fiber location pins which are cantilevered while the mold is open. A problem exists with cantilevered fiber location pins in that, due to a lack of rigidity, the pins can bend or be relatively easily damaged. A bend or deformation as little as about 5 microns of the mold pins can result in the discrete fiber holes in the ferrule being misaligned. Thus, the resultant molded ferrule could be defective with a bend or deflection of the mold pins of as little as 5 microns. U.S. Pat. No. 5,963,691 discloses an alignment system in a connector ferrule for a fiber optic cable. The connector ferrule includes a ferrule body having a fiber passage which is elongated in cross-section to receive an entire line of optical fibers. However, this type of ferrule does not provide individual respective supports for each of the optical fibers. Therefore, the optical fibers can be misaligned relative to each other and/or the ferrule at a front of the ferrule.

There is a desire to provide a one-piece optical connector ferrule which can directly contact individual respective optical fibers to precisely locate ends of the optical fibers relative to each other. However, there is also a desire to reduce the problems encountered with fiber location pins in a ferrule forming mold. Therefore, there is a desire to provide an optical connector ferrule molding apparatus having a mold member with a substantially rigid optical fiber location projection that can form separate optical fiber receiving areas in a one-piece optical connector ferrule.

### SUMMARY OF THE INVENTION

In accordance with one embodiment of the present invention, an optical connector ferrule is provided comprising a main section comprising an optical cable receiving area having a slot, and side sections on opposite lateral sides of the main section. The optical slot forms a plurality of optical member receiving areas which are sized and shaped to receive a plurality of spaced optical members and keep the optical members spaced from each other in the slot.

In accordance with another embodiment of the present invention, an optical connector ferrule is provided comprising a main section comprising an optical cable receiving area extending between a rear side and a front side of the main section, and an opening into the cable receiving area from another side of the main section; and lateral side sections on opposite lateral sides of the main section. Each lateral side section comprises a hole for receiving a guide pin. The optical cable receiving area comprises a slot into the front side of the main section. The slot has top and bottom surfaces with a general sinusoidal shape.

In accordance as with another embodiment of the present invention, an optical connector ferrule forming mold is provided comprising at least two mold members movable relative to each other and forming a mold cavity. The improvement comprises a first one of the mold members comprising an optical fiber location shelf extending in a cantilever fashion into the mold cavity. The shelf has top and bottom surfaces with a general wavy shape. The shelf is adapted to form a slot in a formed optical connector ferrule. The slot is formed by the shelf with top and bottom surfaces with general wavy shapes.

### BRIEF DESCRIPTION OF THE DRAWINGS

The foregoing aspects and other features of the present invention are explained in the following description, taken in connection with the accompanying drawings, wherein:

FIG. 1 is a perspective view of an end of an optical cable and connector assembly incorporating features of the present invention;

FIG. 2 is a partial cross sectional view of the cable and connector assembly shown in FIG. 1;

FIG. 3 is a perspective view of the optical connector ferrule used in the assembly shown in FIGS. 1 and 2;

FIG. 4 is a front elevational view of the ferrule shown in FIG. 3 with optical fibers located in the optical member receiving areas;

FIG. 4A is a partial enlarged front elevational view of the ferrule and one of the optical fibers as shown in FIG. 4;

FIG. 5 is an exploded perspective view of an optical connector ferrule mold used to manufacture the optical connector ferrule shown in FIG. 3;

FIG. 6 is a partial enlarged perspective view of an alternate embodiment of the optical member receiving area molding shelf shown in FIG. 5;

FIG. 7A is a partial enlarged front elevational view of an alternate embodiment of the ferrule and one of the optical fibers shown in FIG. 4A;

FIG. 7B is a partial enlarged front elevational view of an alternate embodiment of the ferrule and one of the optical fibers shown in FIG. 4A; and

FIGS. 8-12 are schematic illustrations of alternate embodiments of optical connector ferrules having different shape optical member receiving slots.

### DETAILED DESCRIPTION OF THE PREFERRED EMBODIMENTS

Referring to FIG. 1, there is shown a perspective view of an end of an optical connector and cable assembly 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

The assembly 10 generally comprises an optical cable 12 and an optical connector 14. The cable 12 generally comprises a plurality of optical members or fibers 15 and an outer cover 13. The optical connector 14 generally comprises an outer housing 16, a ferrule and cable subassembly 18, and a spring 20. The subassembly 18 is movably mounted to the outer housing 16. The spring 20 biases the subassembly 18 in a forward position relative to the outer housing 16. However, in an alternate embodiment, any suitable type of outer housing could be provided. In addition, the spring 20 might not be provided. Alternatively, any suitable type of system to bias the subassembly in a forward position could be provided.

Referring also to FIG. 2, a cross sectional view of the subassembly 18 is shown. The subassembly 18 generally comprises an end of the cable 12, an optical connector ferrule 22, a fastener 24, and two alignment pins 26. In an alternate embodiment the alignment pins 26 might not be provided. Alternatively, any suitable type of alignment system could be used for aligning the subassembly 18 with a mating subassembly.

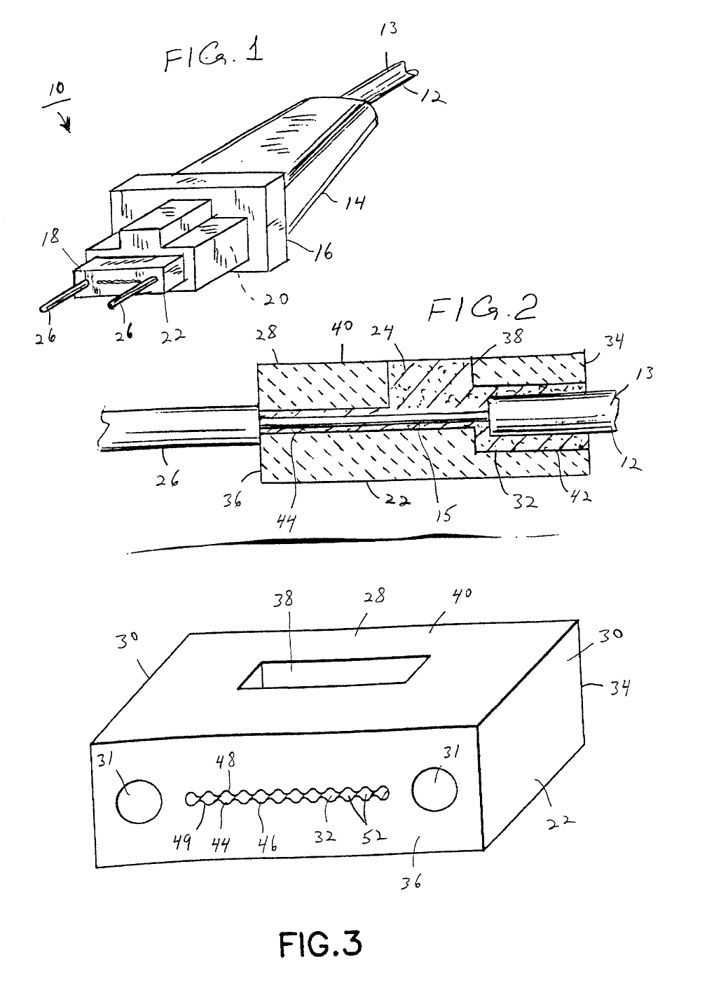

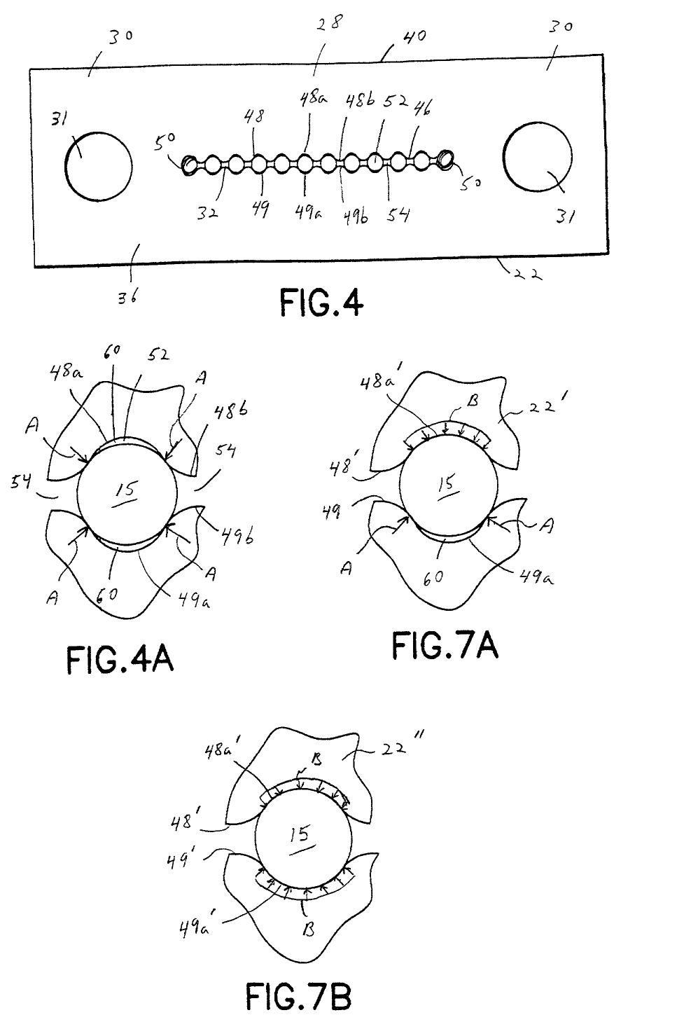

Referring also to FIGS. 3 and 4, the optical connector ferrule 22 is provided as a one-piece member. However, in alternate embodiments, the ferrule could be comprised of more than one piece. In this embodiment, the optical fiber ferrule 22 is comprised of a molded ceramic material. However, in alternate embodiments, the ferrule could be comprised of any suitable type of material(s). The ferrule 22 generally comprises a main section 28 and two side sections 30. The side sections 30 are located on opposite lateral sides of the main section 28. In this embodiment, each side section 30 comprises a hole 31. The alignment pins 26 are located in the holes 31 and project outward from the front face 36 of the ferrule 22. However, in alternate embodiments, any suitable type of side sections could be provided.

The main section 28 comprises an optical cable receiving area 32 extending between a rear side 34 and a front side 36 of the main section. The main section 28 also comprises an opening 38 into the cable receiving area 32 from a top side 40 of the main section. In an alternate embodiment the opening 38 could extend into the cable receiving area 32 from any suitable side.

The cable receiving area 32 generally comprises a rear section 42 and a front section 44. The rear section 42 is preferably slightly larger than the cross sectional size of the cable 12. The opening 38 preferably extends into an area between the rear section 42 and the front section 44.

The front section 44, in the embodiment shown, generally comprises a single elongated slot 46. However, in alternate embodiments, the front section 44 could comprise more than one slot. For example, a plurality of slots could be aligned one above the other. Alternatively, two or more slots could be aligned laterally relative to each other. Top and bottom sides 48, 49 of the slot 46 each have a general wavy shape which extends along the length of the front section 44. In this embodiment, the top and bottom sides 48, 49 have general sinusoidal shapes. However, in alternate embodiments, the top and bottom sides could have any suitable type of wavy shape. Ends 50 of the slot 46 have general sideways teardrop shapes. However, the ends of the slot could have any suitable type of shape.

Recessed areas 48a on the top side 48 are aligned with the recessed areas 49a on the bottom side 49 of the slot. This forms optical member receiving areas 52. Likewise, projections 48b on the top side 48 are aligned with the projections 49b on the bottom side 49 of the slot 46. This forms separator sections 54 between the optical member receiving areas 52. A gap is provided between the projections 48b, 49b. In a preferred embodiment, the gap is less than about 0.125 mm in height, such as about 0.1 mm. However, any suitable gap height could be provided.

Referring back to FIG. 2, the end of the optical fiber cable 12 has a portion of its cover 13 removed to expose the optical fibers 15. The cable 12 is inserted into the receiving area 32 through the rear end 34 of the ferrule 22. A portion of the cable 12 having the cover 13 is located in the rear section 42 of the receiving area. The optical fibers 15 extend into the front section 44 of the receiving area. As the optical fibers 15 are inserted into the front section 44, the front ends of the fibers 15 are each aligned with respective individual ones of the optical member receiving areas 52. The fibers 15 are slid along the receiving areas 52 until front ends of the fibers 15 reached the front end 36 of the ferrule 22. Top and bottom sides of the fibers 15 contact the top and bottom sides 48, 49 of the slot in the receiving areas 52. The sides 48, 49 in the receiving areas 52 are adapted to substantially precisely locate the front ends of the fibers 15 relative to each other and relative to the ferrule 22 in a predetermined position and array.

Referring also to FIG. 4A, a partial enlarged view of one of the receiving areas 52 is shown with one of the optical fibers 15 therein. In this embodiment, the sinusoidal shapes of the top and bottom sides 48, 49 of the slot 46 form four contact areas, as shown by arrows A, between the optical fiber 15 and the ferrule 22. However, in alternate embodiments, any suitable number of contact areas could be provided. The four contact areas A function to substantially precisely aligned the fiber 15 in the receiving area 52. Gaps 60 can be formed between the top and bottom sides of the optical fiber 15 and the ferrule 22 to allow the fastener 24 to extend therethrough. The gaps at the separator sections 54 can also receive the fastener therein to fixedly attached the optical fibers 15 to the ferrule 22.

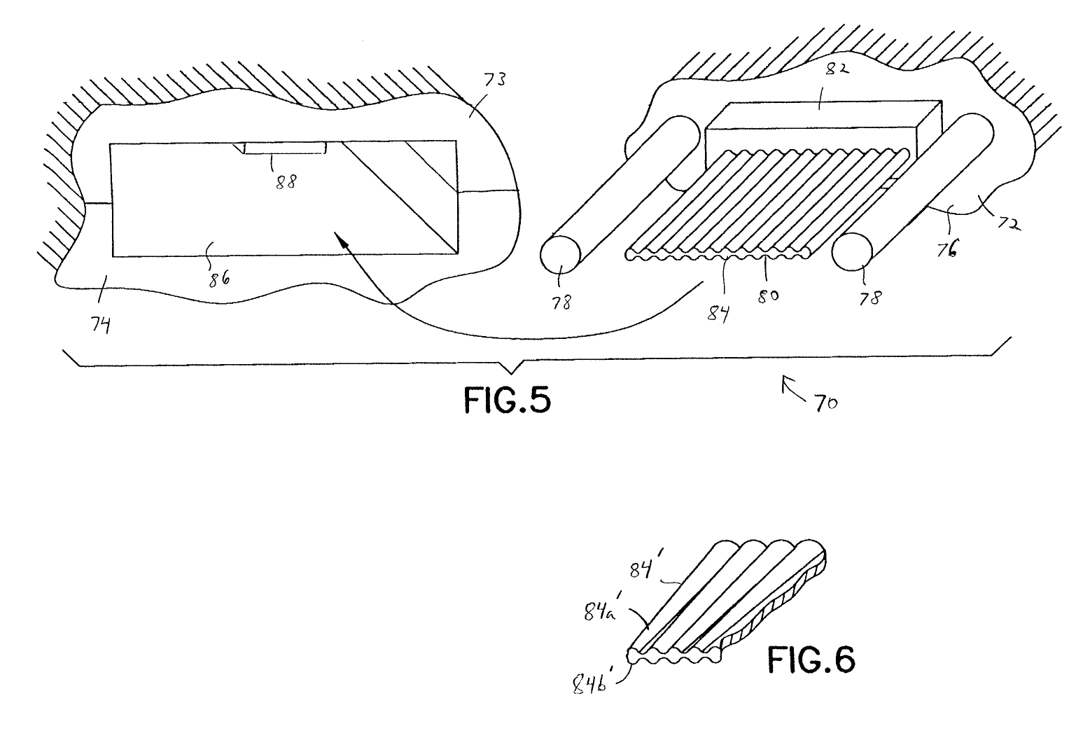

The fastener 24, in a preferred embodiment, is comprised of an epoxy material. However, in alternate embodiments, any suitable type of fastener or fastening material could be used. In the embodiment shown, the epoxy 24 is injected into the opening 38. The epoxy 24 flows into the front and rear sections 44, 42 of the receiving area 32 and, when it hardens, fixedly attaches the end of the cable 12 and the exposed fibers 15 in the receiving area 32 to the ferrule 22. Referring now also to FIG. 5, there shown a perspective exploded view of an optical connector ferrule forming mold 70 used to manufacture the ferrule 22 shown in FIG. 3. The mold 70 generally comprises a plurality of mold members 72,73,74. A first mold member 72 generally comprises a main section 76, alignment pin hole forming sections 78, and a cable receiving area forming section 80. The alignment pin hole forming sections 78 extended in a forward direction in a general cantilever fashion from the main section 76. The cable receiving area forming section 80 generally comprises a rear block section 82 and a front optical member location forming shelf 84. The cable receiving area forming section 80 also projects forward in a general cantilever fashion from the main section 76. The front optical member location forming shelf 84 has top and bottom wavy surfaces. The size and shape of the shelf 84 substantially matches the size and shape of the slot 46. The size and shape of the rear block section 82 substantially matches the size and shape of the rear section 42 of the cable receiving area 32.

The second and third mold members 73,74 form a receiving area 86. The receiving area 86 is about the same size and shape as the outer dimensions of the ferrule 22. The second mold member 73 as a downward projection 88. The downward projection 88 is used to form the opening 38 in the ferrule 22. The forming sections 78,80 are inserted into the receiving area 86 with the main section 76 closing the large opening into the receiving area 86. A suitable material, such as a ceramic material, is then injected into the receiving area 86 to form the ferrule 22 by injection molding.

One of the features of the present invention is in regard to the mold member 72. In particular, the shelf 84 is sized and shaped to form a plurality of individual spaced optical member receiving areas. However, the shelf 84 has a much more rigid structure than a conventional ferrule mold member which has individual cantilevered pins to form separate optical fiber receiving areas. This is a very significant feature in view of the small dimensions involved. For example, individual cantilevered optical fiber receiving area forming pins in a conventional mold member might only have a diameter of about 0.125 mm. Such a small size pin is prone to damage. With the present invention, the wavy shape of the top and bottom sides of the shelf 84 form a general corrugated shape. This corrugated shape, in combination with the shelf shape of the shelf section 84, combine to produce a much more rigid structure than conventional cantilevered pins. Therefore, the shelf 84 is much less likely to deform, bend or otherwise be damaged with the passage of time. The mold 70 will, therefore, have a longer working life and form ferrules with much less quality-control problems than conventional ferrule molds which have individual cantilevered optical fiber receiving area forming pins. In an alternate embodiment, the shelf 84 could comprise relatively small length pin sections at its front leading end.

Referring also to FIG. 6, a partial enlarged view of an alternate embodiment of the shelf 84′ is shown. In this embodiment, the shelf 84′ has top and bottom projections 84a′ and 84b′ which increase in side from front to rear. This type of shelf forms optical fiber receiving areas in a ferrule that taper from rear to front. This can help in sliding insertion of the fibers 15 into their respective receiving areas. Alternatively, any suitable type of guide or taper at the rear end of the front section 44 of the cable receiving area could be provided. Correspondingly, the shelf could be provided with any suitable type of shape to form the guide or lead-in taper at the rear end of the cable receiving area's front section.

Referring now also to FIGS. 7A and 7B, alternate embodiments of the optical member receiving areas, and the top and bottom sides 48, 49 of the slot 46 in the ferrule 22, will be described. In the embodiment shown in FIG. 7A the ferrule 22′ has a front section of its slot with the bottom surface 49, but has a different top surface 48′. The top surface 48′ has a wavy shape similar to the bottom surface 49, but with different dimensions. In this embodiment, the curvature of the recessed section 48a′ substantially matches the outer dimension or curvature of the optical fiber 15. This creates a three-point contact at areas A, A and B. In the embodiment shown in FIG. 7B the ferrule 22″ has its slot with the top surface 48′, but a different bottom surface 49′. The bottom surface 49′ is substantially a mirror image of the top surface 48′. The curvature of the recessed section 49a′ substantially matches the outer dimensions or curvature of the optical fiber 15. This creates a slip fit between the optical fiber 15 and the ferrule 22″ at areas B and B. In alternate embodiments, any suitable type or number of contact areas between the outer surface of the optical fibers 15 and the top and bottom surfaces of the slot could be provided.

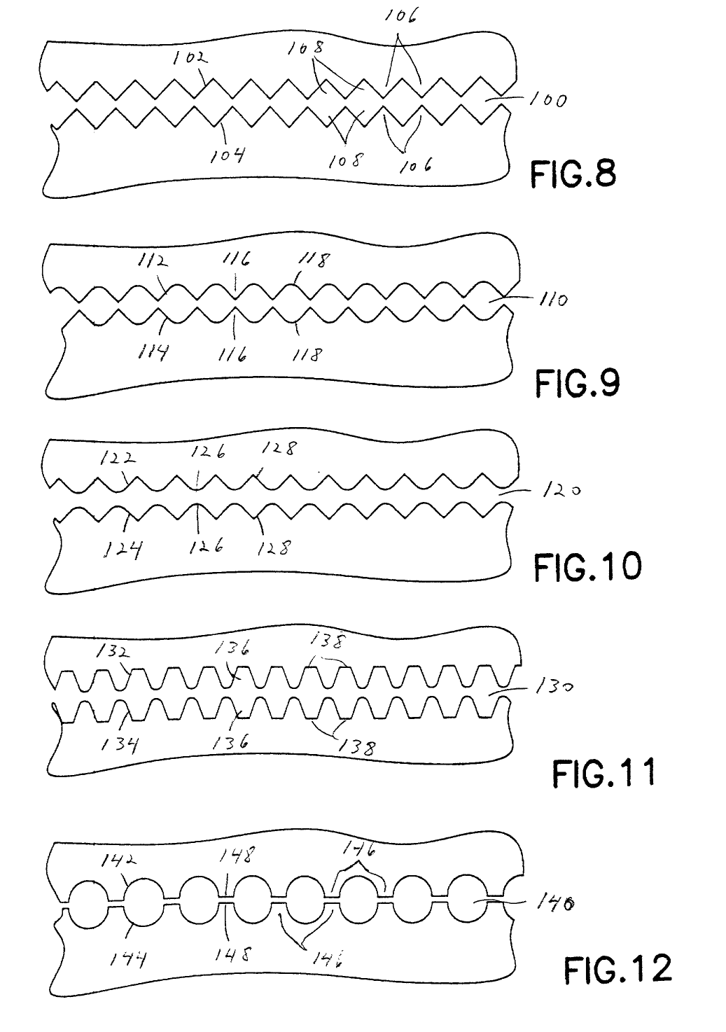

Referring now to FIGS. 8-12, alternate embodiments of the front slot in a ferrule for receiving and separately supporting multiple optical fibers will be described. FIG. 8 illustrate that the top and bottom sides 102, 104 of the slot 100 could be comprised of general saw tooth shaped projections and recesses 106, 108. FIG. 9 illustrates that the top and bottom sides 112, 114 of the slot 110 could be comprised of general pointed shaped projections 116 and curved shaped recesses 118. FIG. 10 illustrates that the top and bottom sides 122, 124 of the slot 120 could be comprised of general pointed shaped recesses 126 and curved shaped projections 128. FIG. 11 illustrates that the top and bottom sides 132, 134 of the slot 130 could be comprised of recesses 136 having general flat shaped bottom sections 138. FIG. 12 illustrates that the top and bottom sides 142, 144 of the slot 140 could be comprised of projections 146 having flat shaped surfaces 148. All of the slots could be formed by a respective mold member having a single shelf section to form the slot.

The different shaped surfaces and slots shown in FIGS. 8-12 are merely intended to illustrate that the slot and the surfaces that form the slot could have any suitable type of shapes. The embodiments shown in FIGS. 8-12 still provide general wavy shaped top and bottom surfaces. As used herein, the term “wavy” is intended to mean alternating projections and recesses along a surface, but the projections and recesses might not be uniform, such as projections and/or recesses along a surface which have different sizes or shapes. Multiple size or shape projections and/or recesses could be provided on one or both of the top and bottom surfaces that form the slot. One of the top or bottom surfaces in the slot might not have a wavy shape. In addition, the projections and recesses might not be precisely aligned with each other. In an alternate embodiment, the projections and recesses could be slightly offset from each other.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An optical connector ferrule comprising:
a main section comprising an optical cable receiving area having a slot, and
side sections on opposite lateral sides of the main section,
wherein the slot forms a plurality of optical member receiving areas which are sized and shaped to receive a plurality of spaced optical members and keep the optical members spaced from each other in the slot.

2. An optical connector ferrule as in claim 1 wherein the main section and the side sections are integrally formed in a one-piece ferrule member.

3. An optical connector ferrule as in claim 1 wherein the optical cable receiving area comprising the slot which extends into a front side of the main section, a relatively larger rear area at a rear end of the slot which extends into a rear side of the main section, and a hole through another side of the main section which communicates with the slot and the rear area.

4. An optical connector ferrule as in claim 1 wherein top and bottom surfaces of the slot have a general wavy shape.

5. An optical connector ferrule as in claim 1 wherein top and bottom surfaces of the slot have a general sinusoidal shape.

6. An optical connector ferrule as in claim 5 wherein downward projections on the top surface of the slot are substantially aligned with upward projections on the bottom surface of the slot.

7. An optical connector ferrule as in claim 6 wherein a gap is provided between the downward projections and the upward projections.

8. An optical connector ferrule as in claim 7 wherein the gap is less than about 0.125 mm in height.

9. An optical connector ferrule as in claim 5 wherein at least one of the top and bottom surfaces have projections and adjacent recesses which vary in size along a length of the slot.

10. An optical connector ferrule as in claim 1 wherein the side sections each comprise a locating pin hole extending into a front face of the side sections.

11. An optical connector ferrule as in claim 1 wherein opposite lateral ends of the slot have general sideways teardrop shapes.

12. An optical connector ferrule as in claim 1 wherein a plurality of the optical member receiving areas each have a general diamond shape with interconnected lateral ends.

13. An optical connector ferrule comprising:
a main section comprising an optical cable receiving area extending between a rear side and a front side of the main section, and an opening into the cable receiving area from another side of the main section; and
lateral side sections on opposite lateral sides of the main section, each lateral side section comprising a hole for receiving a guide pin,
wherein the optical cable receiving area comprises a slot, and wherein the slot has top and bottom surfaces with general sinusoidal shapes.

14. An optical connector ferrule as in claim 13 wherein the main section and the side sections are integrally formed in a one-piece ferrule member.

15. An optical connector ferrule as in claim 13 wherein downward projections on the top surface of the slot are substantially aligned with upward projections on the bottom surface of the slot.

16. An optical connector ferrule as in claim 15 wherein a gap is provided between the downward projections and the upward projections.

17. An optical connector ferrule as in claim 16 wherein at least one of the top and bottom surf aces have projections and adjacent recesses which vary in size along a length of the slot.

18. An optical connector ferrule as in claim 13 wherein opposite ends of the slot have general sideways teardrop shapes.

19. In an optical connector ferrule forming mold comprising at least two mold members movable relative to each other and forming a mold cavity, the improvement comprising:
a first one of the mold members comprising an optical fiber location shelf extending in a cantilever fashion into the mold cavity, the shelf having top and bottom surfaces with a general wavy shape, wherein the shelf is adapted to form a slot in a formed optical connector ferrule, wherein the slot is formed by the shelf to have top and bottom surfaces with general wavy shapes.

20. An optical connector ferrule forming mold as in claim 19 wherein the general wavy shape of the top and bottom surfaces have a general sinusoidal shape.

21. A method of manufacturing an optical connector comprising steps of:
providing an optical connector ferrule having an optical cable receiving area, the optical cable receiving area comprising a slot extending into a front end of the ferrule, the slot having generally wavy top and bottom surfaces to form a plurality of laterally connected individual optical fiber receiving areas;
inserting optical fibers into respective individual ones of the optical fiber receiving areas, the optical fiber receiving areas locating ends of the optical fibers relative to each other at a predetermined position at the front end of the ferrule; and
inserting a fastener into the optical cable receiving area to stationarily fix the cable inside the ferrule and the optical fibers in the optical fiber receiving areas.

22. A method as in claim 21 wherein the step of providing An optical connector ferrule comprises providing the wavy top and bottom surfaces of the slot with general sinusoidal shapes.

23. A method as in claim 21 wherein the step of inserting a fastener comprises injecting epoxy into the optical cable receiving area.
